(19) United States
(12) Patent Application Publication
(10) Pub. No.: US 2005/0086057 A1
(43) Pub. Date: Apr. 21, 2005

(54) Speech recognition apparatus and its method and program

(76) Inventors: Tetsuo Kosaka, Yamagata-ken (JP); Keiichi Sakai, Tokyo (JP); Hiroki Yamamoto, Tokyo (JP)

Correspondence Address: FITZPATRICK CELLA HARPER & SCINTO, 30 ROCKEFELLER PLAZA, NEW YORK, NY, 10112, US

(21) Appl. No.: 10/490,696

(22) PCT Filed: Nov. 13, 2002
(86) PCT No.: PCT/JP02/11822

(30) Foreign Application Priority Data
Nov. 22, 2001 (JP) 2001-357746

(51) Int. Cl. G10L 15/00

(52) U.S. Cl. 704/251

(57) ABSTRACT

Data including a description for displaying input columns and a description concerning speech recognition grammars for the input columns is read. By using speech recognition grammars corresponding to a plurality of input columns displayed on the basis of the data, speech recognition on the input speech is conducted. On the basis of the speech recognition grammars, input columns of input destinations of the speech recognition result are determined from a plurality of input columns and the input columns of input destinations are displayed in corresponding input columns.

### TECHNICAL FIELD

The present invention relates to a speech recognition apparatus for recognizing input speech and its method, and a program.

### BACKGROUND ART

The conventional implementation of the speech recognition technique is typically conducted by creating a program. In recent years, however, implementation of the speech recognition technique is conducted by using a hypertext document such as VoiceXML. As described in Japanese Patent Applications Laid-Open No. 2001-166915 and No. 10-154063 in the VoiceXML, only speech is basically used as input and output means (strictly speaking, DTMF or the like is used). However, it is also contrived to use a hypertext document not only for speech inputting and outputting but also for description of a UI using GUI as well.

In such a scheme, a markup language such as HTML is used for description of GUI, and in addition, some tags corresponding to the speech input and speech output are added in order to make possible speech inputting and outputting.

On the other hand, in the so-called multi-modal user interface using GUI with the speech inputting and outputting, it becomes necessary to describe how modalities, such as speech inputting using speech recognition, speech outputting using speech synthesis, inputting from the user using GUI, and presentation of information using graphics, are linked. For example, in Japanese Patent Application Laid-Open No. 2001-042890, there is disclosed a method in which a button is associated with an input column and a speech input and depression of the button causes the associated input column to be selected and a speech recognition result to be input into the column.

In an apparatus according to Japanese Patent Application Laid-Open No. 2001-042890, however, selection of any one item with a button can cause speech to be input into an input column associated therewith. It has a feature that in speech recognition not only words but also free speech such as a sentence can be input. For example, if one utterance “From Tokyo to Osaka, one adult” is conducted in a ticket sales system using the multi-modal user interface, then four pieces of information in the one utterance, i.e., a departure station, a destination station, a kind of a ticket, and the number of tickets can be input in a lump.

Furthermore, it is also possible to utter them separately and input them. When it is attempted to associate such a continuous input with an input column of GUI, association having a degree of freedom becomes necessary. For example, it is necessary that one utterance is not limited to one input column, but it fills a plurality of input columns simultaneously. The above described proposal cannot cope with such an input method.

### DISCLOSURE OF THE INVENTION

The present invention has been made in order to solve the above described problem. An object of the present invention is to provide a speech recognition apparatus capable of implementing speech inputting having a degree of freedom and its method, and a program.

A speech recognition apparatus according to the present invention achieving the object has a following configuration including:
reading means for reading data, the data including a description for displaying input columns and a description concerning speech recognition grammars for the input columns;
speech recognition means for conducting speech recognition on the input speech by using the speech recognition grammars; and
display means for determining input columns of input destinations of the speech recognition result from the plurality of input columns on the basis of the speech recognition grammars; and displaying the input columns of input destinations in corresponding input columns.

### BRIEF DESCRIPTION OF THE DRAWINGS

FIG. 1 is a diagram showing a configuration of a speech recognition system in a first embodiment according to the present invention;

FIG. 2 is a flow chart showing an operation flow of a speech recognition system in the first embodiment according to the present invention;

FIG. 3 is a diagram showing an example of document data in the first embodiment according to the present invention;

FIG. 4 is a diagram showing an example of GUI in the first embodiment according to the present invention;

FIG. 5 is a diagram showing an example of grammar data in the first embodiment according to the present invention;

FIG. 6 is a diagram showing an example of different grammar data in the first embodiment according to the present invention;

FIG. 7 is a diagram showing an example of data held in a grammar/input column correspondence holding section in the first embodiment according to the present invention;

FIG. 8 is a diagram showing an example of data held in an input data holding section in the first embodiment according to the present invention;

FIG. 9 is a diagram showing an example of document data in a second embodiment according to the present invention;

FIG. 10 is a diagram showing an example of GUI in the second embodiment according to the present invention;

FIG. 11 is a flow chart showing an operation flow of a speech recognition system in the second embodiment according to the present invention;

FIG. 12 is a diagram showing a configuration of a speech recognition system in a fourth embodiment according to the present invention;

FIG. 13 is a flow chart showing an operation flow of a speech recognition system in the fourth embodiment according to the present invention;

FIG. 14 is a diagram showing an example of document data in the fourth embodiment according to the present invention;

FIG. 15 is a diagram showing an example of data held in the grammar/input column correspondence holding section in the fourth embodiment according to the present invention;

FIG. 16A is a diagram showing an example of grammar data in the fourth embodiment according to the present invention;

FIG. 16B is a diagram showing an example of the grammar data in the fourth embodiment according to the present invention;

FIG. 17 is a diagram showing an example of the document data in a sixth embodiment according to the present invention;

FIG. 18 is a diagram showing an example of GUI in the sixth embodiment according to the present invention;

FIG. 19 is a diagram showing an example of the document data in a seventh embodiment according to the present invention; and

FIG. 20 is a diagram showing an example of different document data in the seventh embodiment according to the present invention.

### BEST MODE FOR CARRYING OUT THE INVENTION

Hereafter, preferred embodiments of the present invention will be described in detail with reference to the drawings.

First Embodiment

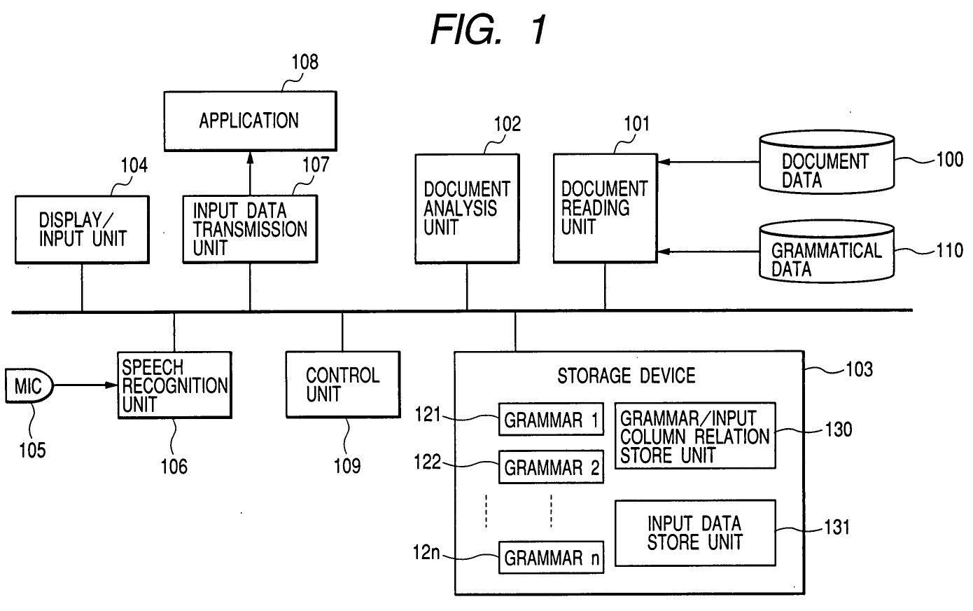

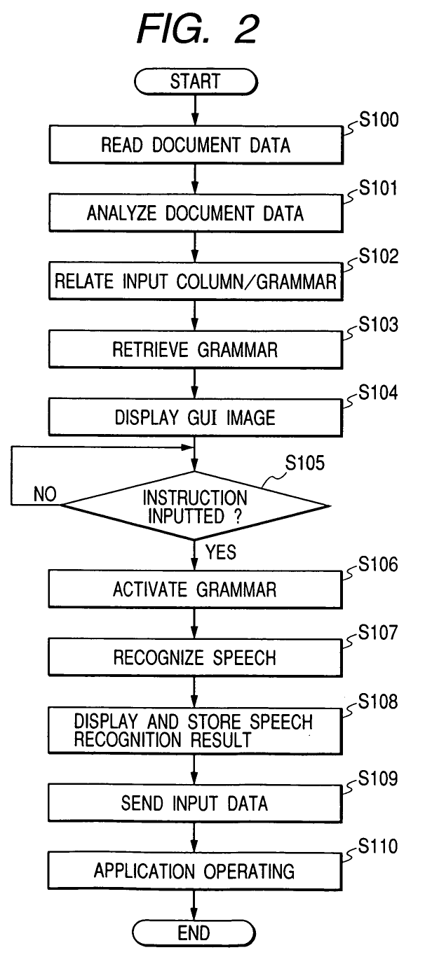

FIG. 1 is a diagram showing a configuration of a speech recognition system in a first embodiment according to the present invention. FIG. 2 is a flow chart showing an operation flow of the speech recognition system in the first embodiment according to the present invention. Hereafter, an operation example will be described with reference to FIGS. 1 and 2.

The speech recognition system can conduct data communication via a network such as a public line, a radio LAN, or the like, and includes standard components (such as a CPU, a RAM, a ROM, a hard disk, an external storage device, a network interface, a display, a keyboard, and a mouse), which are mounted on a general purpose computer and a mobile terminal. Furthermore, various functions implemented in the speech recognition system described hereafter may be implemented by a program stored in the ROM or the external storage device in the system and executed by the CPU, or may be implemented by dedicated hardware.

First at step S100, document data 100 is read by using a document reading section 101. Document data is a hypertext document formed of descriptions of a description language such as the markup language. The document data contains descriptions that represent a GUI design, operation of speech recognition and synthesis, a location of a speech recognition grammar (storage location), and text data of a display subject/speech output subject.

Subsequently, at step S101, an analysis of the read document data 100 is effected by using a document analysis section 102. At this step, an analysis of the markup language in the document data 100 is effected, and an analysis as to what structure the document data 100 has is effected.

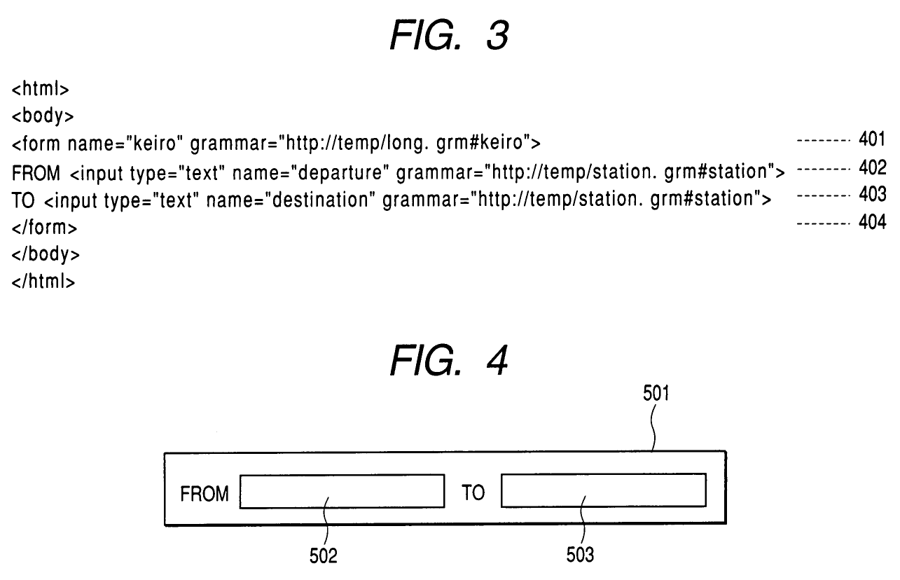

An example of the document data 100 to be analyzed is shown in FIG. 3. An example of this displayed in GUI is shown in FIG. 4.

“Input” tags 402 and 403 shown in FIG. 3 are displayed as input columns 502 and 503 in the GUI of FIG. 4. “Form” tags 401 and 404 shown in FIG. 3 are displayed by a frame 501, which surrounds the input columns 502 and 503 in FIG. 4, to display which input element (for example, “input”) is contained in the “form”. The “form” tag 401 can set attributes for a plurality of input columns represented by “input” tags. In the case of FIG. 3, the two “input” tags 402 and 403 interposed between the “form” tags 401 and 404 are contained in a “form” name “keiro”. An attribute “grammar” contained in the “form” tag 401 and the “input” tags 402 and 403 indicates a location at which the speech recognition grammar (hereafter abbreviated to simply as grammar) is held. The grammar data may be managed by an external terminal on a network within or outside the speech recognition system.

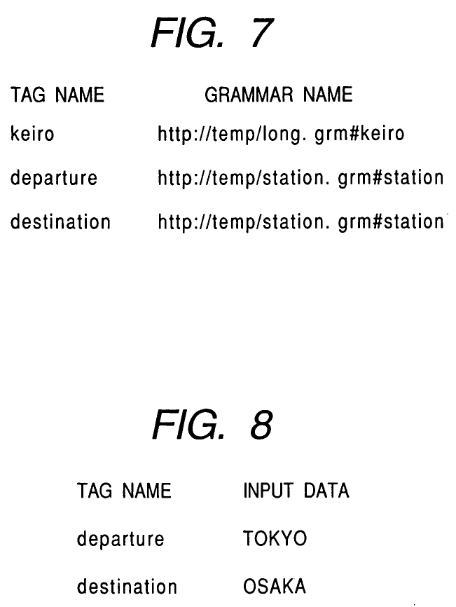

At step S102, a control section 109 derives correspondence relations between input columns and grammars on the basis of the analysis result of the document analysis section 102. In the first embodiment, grammar “http://temp/long.grm#keiro” corresponds to a “form” having a name “keiro”, grammar “http://temp/station.grm#station” corresponds to an “input” having a name “departure”, and grammar “http://temp/station.grm#station” corresponds to an “input” having a name “destination”. These correspondence relations are held in a grammar/input column correspondence holding section 130 in a storage device 103 in, for example, a form shown in FIG. 7.

At step S103, grammar data 110 is read by the document reading section 101 and stored in a storage device 103. The grammar data 110 thus read are all grammars described in the document data 100. In the first embodiment, in the tags 401, 402 and 403 shown in FIG. 3, three grammar data 110 indicated by “grammar=” are read from locations at which they are described, and stored in the storage device 103. In the case of the same grammar as in 402 and 403, it is not necessary to read it doubly. The read grammar data are denoted by 121, 122, . . . , 12n.

At step S104, an image based upon the analysis result of the document analysis section 102 is displayed in a display section/input section 104. A display example at this time is shown in FIG. 4. A display section of the display section/input section 104 is typically a computer display. However, anything will do, so long as it can display an image visually.

At step S105, a speech input order from the user is in standby state. The speech input order from the user is given by the display section/input section 104. As for the speech input order, for example, an input order for indicating whether the input is an input to an input element, such as the frame 501, the input column 502, or the input column 503 in FIG. 4, is given by using a microphone 105 or the like. Furthermore, instead of the speech input order, an input order may be given by using a physical button. Or an input order may be given by depressing an input element in the GUI displayed in the display section/input section 104, with a pointing device.

For example, in the case where it is desired to select the frame 501, a part thereof should be pressed with a pointing device. In the case where it is desired to select the input column 502 or 503, a part thereof should be depressed with the pointing device. If an input order is given from the user as heretofore described, the processing proceeds to step S106.

At the step S106, a grammar corresponding to the column selected by the input order is activated. “An activation of grammar” means that the grammar is made usable (made valid) in a speech recognition section 106. The correspondence relation between the selected column and the grammar is acquired in accordance with a correspondence relation held in the grammar/input column correspondence holding section 130.

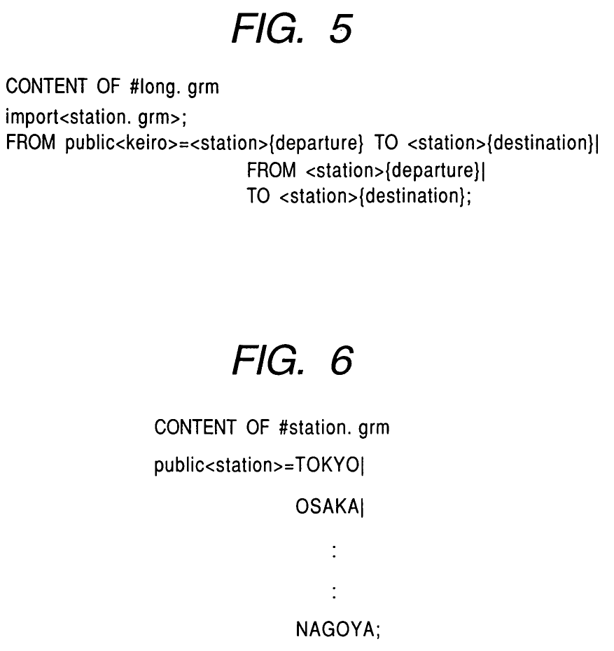

For example, in the case where the frame 501 is selected by the user, a grammar “long.grm” becomes active. Furthermore, in the same way, in the case where the input column 502 has been selected, the grammar “station.grm” becomes active. Also in the case where the input column 503 has been selected, the grammar “station.grm” becomes active. A description example of the grammar “long.grm” is shown in FIG. 5, and a description example of the grammar “station.grm” is shown in FIG. 6.

In the grammar “long.grm” of FIG. 5, utterance, such as “from XX to ◯◯”, “from XX”, and “to ◯◯” can be recognized. Here, as for “XX ” and “◯◯”, contents described in the “station.grm” can be uttered. In other words, one utterance such as “from Tokyo to Osaka”, or intermittent utterance such as “from Nagoya”, or “to Tokyo” can be recognized. Furthermore, in the grammar “station.grm” in FIG. 6, one utterance such as “Tokyo”, “Osaka” or “Nagoya” can be recognized.

At step S107, the speech recognition section 106 conducts speech recognition on speech input by the user with the microphone 105, by using the active grammar.

At step S108, display and holding of a result of the speech recognition are conducted. The speech recognition result is basically displayed in the input column selected by the user at the step S105. If a plurality of input columns have been selected, then from those input columns, on the basis of grammar data 110 corresponding to the plurality of input columns, input columns of input destinations respectively of word groups obtained from the speech recognition result are determined and displayed in the corresponding input columns.

For example, if the user selects the input column 502 and utters “Tokyo”, then text data (Tokyo) corresponding to the utterance is displayed in the input column 502. If utterance is effected with the frame 501 represented by the “form” tag, then the frame 501 includes a plurality of input columns, i.e., the input columns 502 and 503, and consequently an input column for displaying text data corresponding to utterance is determined in accordance with the following method. The method will now be described according to grammar description in FIG. 5.

First, in the grammar description, a portion put in { } is analyzed, and inputting is conducted on a column in the { }. For example, if one utterance “from Tokyo to Osaka” is conducted, then “Tokyo” corresponds to {departure} and “Osaka” corresponds to {destination}. On the basis of this correspondence relation, “Tokyo” is displayed in the input column 502 named “departure” and “Osaka” is displayed in the input column 503 named “destination”. In addition, if “from Nagoya” is uttered, then it is associated with {departure} and consequently it is displayed in the input column 502. If “to Tokyo” is uttered, then it is associated with {destination} and consequently it is displayed in the input column 503.

In other words, if the user has selected the input column 501, then text data corresponding to uttered content is displayed in the input column 502 and then in the input column 503, or simultaneously in the input columns 502 and 503, in accordance with the uttered content. In addition, input data (text data) of respective columns are held in an input holding section 131 together with correspondence relations of the input columns. For example, if “from Tokyo to Osaka” is uttered, then an example of input data held in the input data holding section 131 is shown in FIG. 8.

At step S109, at a time point when an order of input data transmission is given by the user, input data held in the input data holding section 131 is transmitted to an application 108 by an input data transmission section 107. In this case, for example, input data shown in FIG. 8 is transmitted.

At step S110, operation of the application 108 is conducted on the basis of the received input data. For example, retrieval of railroad routes from Tokyo to Osaka is conducted, and a result of the retrieval is displayed in the display section/input section 104.

According to the first embodiment, even if a plurality pieces of information are input in lump with speech in the multi-modal interface using the GUI with speech recognition, the pieces of information can be input into optimum input columns in the GUI as heretofore described. In addition, since the multi-modal interface is provided in a description language such as a markup language, the UI can be customized simply.

Second Embodiment

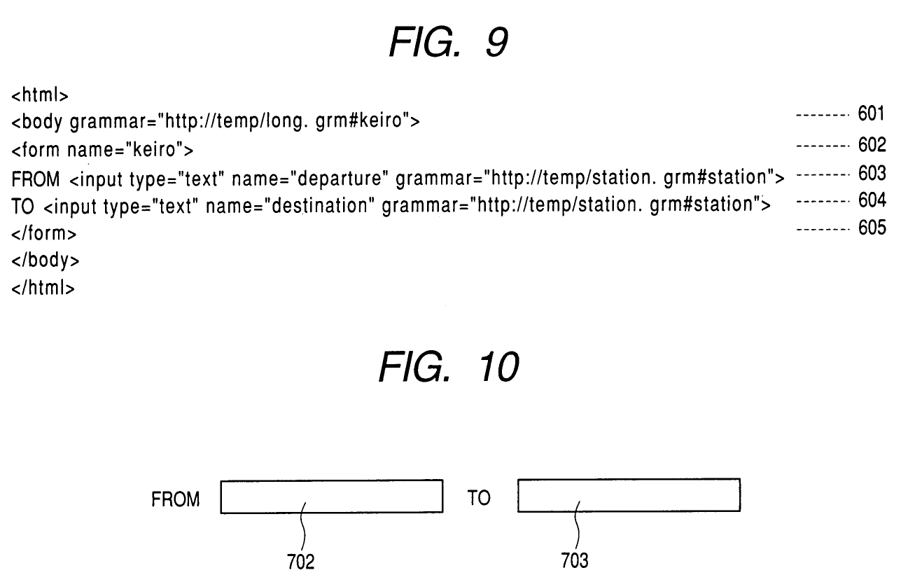

In the first embodiment, the case where an input column is selected by the user has been described. However, a method in which the user does not effect a selection is also possible. An example of the document data 100 in this case is shown in FIG. 9. Furthermore, an example in which this is displayed in the GUI is shown in FIG. 10.

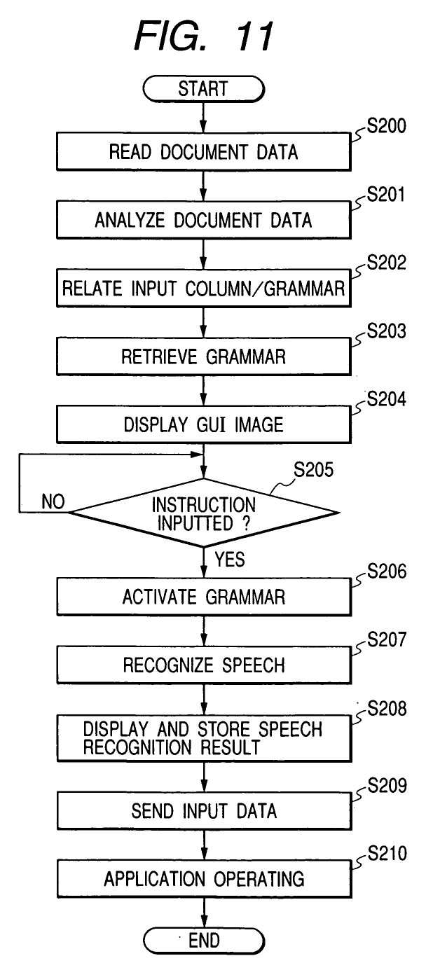

As for the grammars described in 603 and 604 in FIG. 9, operation that is completely the same as that of the first embodiment is conducted, and consequently description thereof will be omitted. On the other hand, since the grammar described in 601 differs in operation from that of the first embodiment, it will be described hereafter with reference to a flow chart in FIG. 11.

FIG. 11 is a flow chart showing an operation flow of a speech recognition system in the second embodiment of the present invention.

In FIG. 11, steps S200 and S201 correspond to the steps S100 and S101 of the first embodiment, and operation of the steps is the same and consequently description thereof will be omitted.

At step S202, the control section 109 derives a correspondence relation between the input column and grammar on the basis of an analysis result of the document analysis section 102. However, the correspondence relation differs from FIG. 7 of the first embodiment, and a tag name corresponding to “http://temp/long.grm#keiro” becomes a blank.

At step S203, the grammar data 110 is read by the document reading section 101. In the second embodiment, all grammars described in the document data 100, inclusive of “http://temp/long.grm#keiro” in FIG. 9, are read.

At step S204, an image based upon an analysis result of the document analysis section 102 is displayed in the display section/input section 104. An example of display at this time is shown in FIG. 10.

At step S205, a speech input order from the user is in standby state. Here, in the same way as the first embodiment, the user can select the input columns 702 and 703. However, the user cannot select the input columns 702 and 703 in a lump. If there is an input order from the user, the processing proceeds to step S206.

At the step S206, a grammar corresponding to the column selected by the input order is activated. A correspondence relation between the selected column and the grammar is acquired in accordance with a correspondence relation held in the grammar/input column correspondence holding section 130. By the way, if a tag name corresponding to a grammar is blank, then the grammar is always made active. In other words, in the second embodiment, “http://temp/long.grm#keiro” becomes active.

Thereafter, steps S207 to S210 correspond to the steps S107 to S110 in FIG. 2 of the first embodiment, and operation of the steps is the same and consequently description thereof will be omitted.

As heretofore described, according to the second embodiment, if in a multi-modal interface using the GUI with speech recognition an input location is previously fixed or it is intentionally desired to prohibit the user from selecting an input column, respective pieces of information can be input to optimum input columns in the GUI even if selection of an input column is prohibited and a plurality of pieces of information are input in a lump with speech.

Third Embodiment

As for which input column displays the speech recognition result in the first embodiment, a portion put in { } in grammar description is analyzed and inputting is conducted to the column described in { }. Even if there is no description in { }, however, the same can be implemented. For example, if the grammar in FIG. 5 is used, then “from Tokyo to Osaka”, “from Nagoya”, “to Tokyo” and so on can be recognized. In other words, a morphological analysis is effected on the speech recognition result of user's utterance, and a statement obtained as the speech recognition result is divided into words. For example, if the speech recognition result is “from Tokyo to Osaka”, then the speech recognition result is divided into, for example, “from/Tokyo/to/Osaka”, “from/Nagoya”, or “to/Tokyo” by using the morphological analysis.

Subsequently, the markup language description in FIG. 3 is analyzed, and input tags placed after “from” and “to” are determined. As a result, it is understood that an input tag named “departure” corresponds to “from” and an input tag named “destination” corresponds to “to”. By using this result, a word placed before “from” is associated with the input column of “departure” and a word placed before “to” is associated with the input column of “destination”, and respective input columns are filled. Owing to the foregoing, it becomes possible to input words to respective columns even if there is no description of { } in the grammar.

Fourth Embodiment

In the first embodiment, corresponding grammar is prepared in order to specify the grammar for inputting speech inputs to a plurality of input columns in a lump. In the case where a combination of input columns or a word order is altered, however, it is necessary to newly generate a corresponding grammar.

In a fourth embodiment, therefore, there will now be described as an application example of the first embodiment a configuration for facilitating the alteration of a combination of input items or a word order by automatically generating a grammar for inputting items in a lump in the case where a grammar is prepared for each input column.

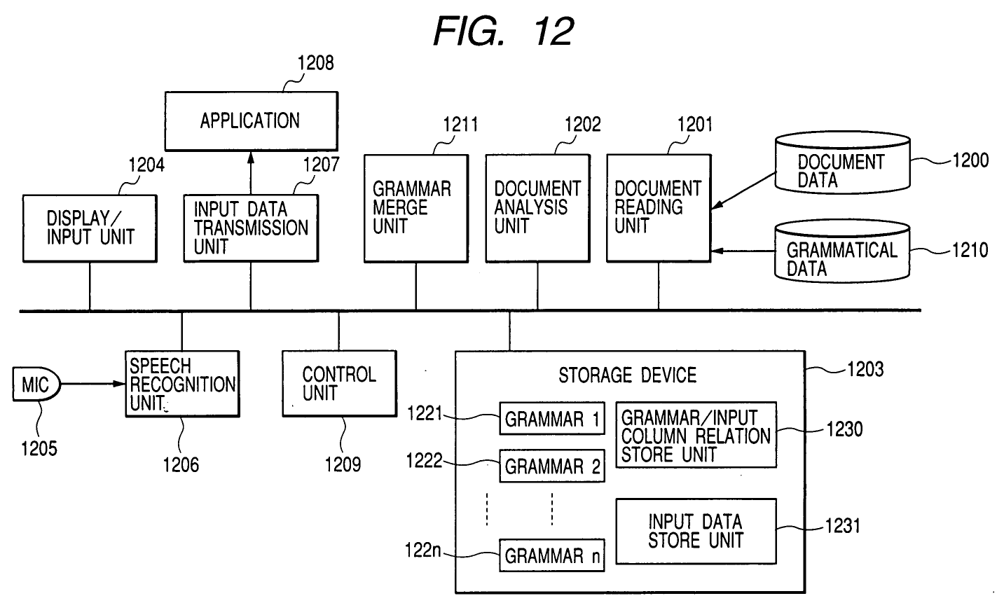

FIG. 12 is a diagram showing a configuration of a speech recognition system of a fourth embodiment.

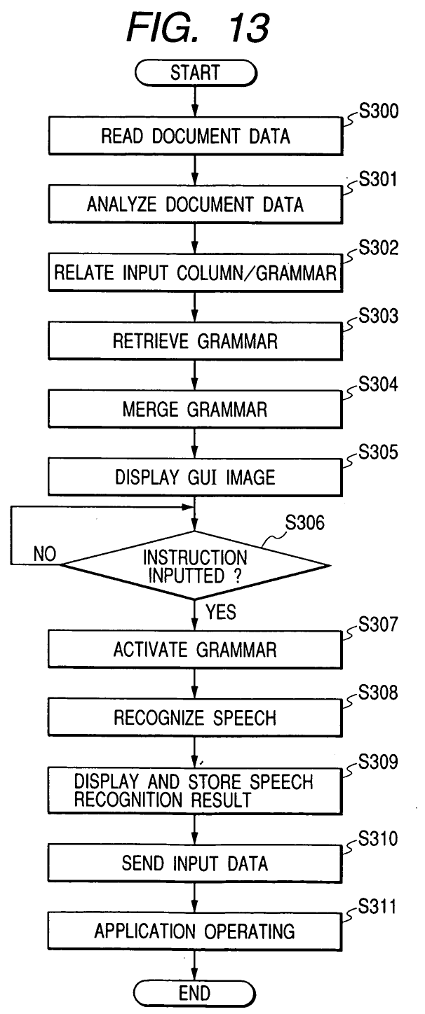

FIG. 12 is a diagram showing a configuration of the speech recognition system of a fourth embodiment according to the present invention. In addition, FIG. 13 is a flow chart showing an operation flow of a speech recognition system of the fourth embodiment according to the present invention. Hereafter, an operation example will be described by using FIGS. 12 and 13.

FIG. 12 shows a configuration obtained by adding a grammar merge section 1211 to the configuration of the speech recognition system of the first embodiment shown in FIG. 1. Components 1200 to 1210, 1230, 1231, 1221, 1222, . . . , 122n correspond to the components 100 to 110, 130, 131, 121, 122, . . . , 12n in FIG. 1.

In FIG. 12, steps S300 and S301 correspond to the steps S100 and S101 in the first embodiment, and operation of the steps is the same and consequently description thereof will be omitted.

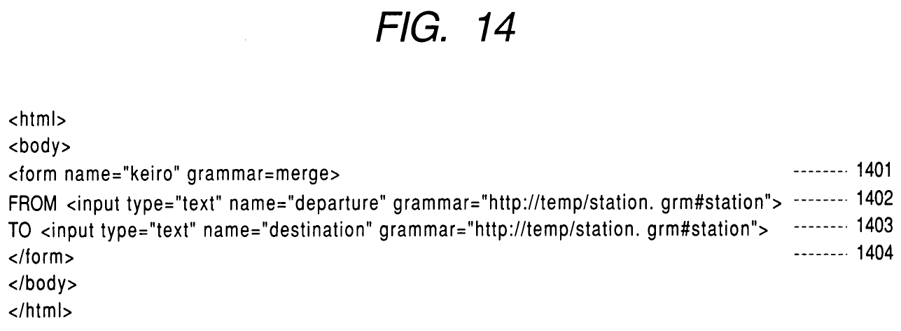

First, an example of the document data 100 to be analyzed at step S301 of the fourth embodiment is shown in FIG. 14. An example in which this is displayed by GUI becomes the one as shown in FIG. 4 described earlier. The document data 100 in FIG. 14 differs from the document data 100 of the first embodiment shown in FIG. 3 in a “grammar” specifying portion of 1401. In other words, unlike the first embodiment, a previously prepared grammar is not specified, but “merge” is described.

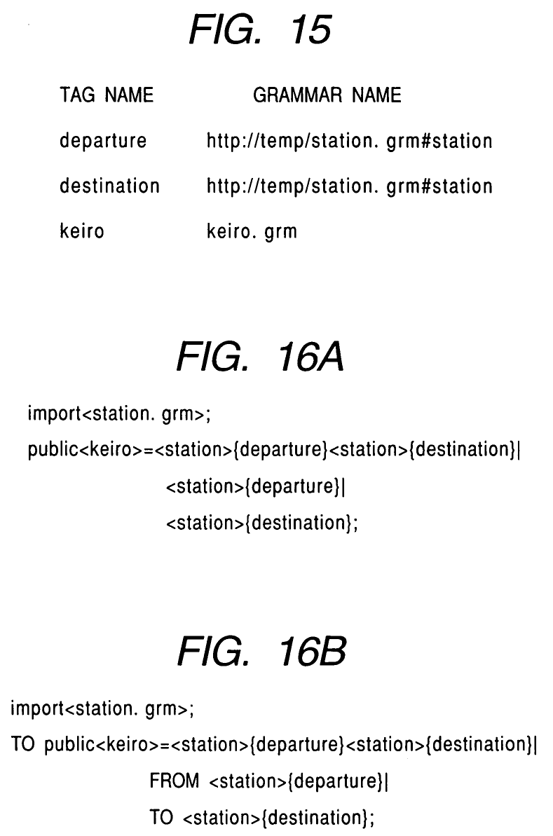

At step S302, the control section 1209 derives correspondence relations between input columns and grammars on the basis of the analysis result of the document analysis section 1202. Processing on the “input” tags 1402 and 1403 is the same as the processing on the “input” tags 402 and 403 of the first embodiment, and consequently description thereof will be omitted. Especially in the fourth embodiment, “merge” is specified for an attribute “grammar” of a “form” having a name of “keiro”. If the “merge” is specified, then in the ensuing processing a grammar for a “form” created by using a grammar described in the “form” is associated. At this stage, the grammar for the “form” does not exist. And correspondence relations held in the grammar/input column correspondence holding section 1230 are held in, for example, a form shown in FIG. 15. In FIG. 15, the grammar for the “form” is represented as “keiro.grm” by using the name of the “form”.

At step S303, grammar data 1210 is read by the document reading section 1201 and stored in the storage device 103. The grammar data 1210 thus read are all grammars described in the document data 100.

If as a result of the analysis effected by the document analysis section 1202 “merge” is specified in the attribute “grammar” of the “form”, a grammar merge section 1211 newly creates a grammar for the “form” that accepts individual inputs to respective “inputs” in the “form” and a lump input of all inputs. By using attribute information of an “input” tag described in the “form”, for example, a grammar for the “form” as shown in FIG. 16A is created. Furthermore, as shown in FIG. 16B, a grammar including a grammar that includes words and/or phrases, such as “from” and “to”, described in the “from” may also be created in the same way as “long.grm” shown in FIG. 5. It is possible to automatically generate such a grammar by analyzing document data 1200 and taking portions other than tags in the grammar.

It is now supposed that individually read grammar data 1210 and grammar data created at the step S304 are 1221, 1222, . . . , 122n. Assuming that grammar data “keiro.grm” created at the step S304 corresponds to the grammar “long.grm”, which corresponds to the “form” described in the first embodiment, and “keiro.grm” is a grammar corresponding to the “form”, processing of subsequent steps S307 to step S311 corresponds to the steps S106 to the step S110 of the first embodiment shown in FIG. 2. Since operation of the steps is the same, description thereof will be omitted.

According to the fourth embodiment, it is possible to automatically generate the grammar for the “form” from grammars used in “inputs” in the “form” as heretofore described, even if the grammar corresponding to the “form” is not previously prepared and specified. Furthermore, if a previously created grammar is specified as in the document data in FIG. 3 used in the first embodiment, the same behavior as that of the first embodiment can be implemented.

In other words, in the multi-modal interface using the GUI with speech recognition, lamp inputting of a plurality of items can be implemented without previously preparing a corresponding grammar, by automatically generating a grammar for inputting a plurality of items in a lump with speech, from grammars associated with respective items. In addition, since the multi-modal interface is provided in a description language such as a markup language, the UI can be customized simply.

Fifth Embodiment

In the fourth embodiment, in the case where there is explicitly a description (“merge” in the fourth embodiment) of merging grammars in the attribute “grammar” of the “form” when the document 1200 is analyzed at the step S301, merging of the grammar data is conducted. However, merging of the grammar data is not restricted to this. For example, in the case where there is no specification of the attribute “grammar” of the “form”, merging of grammars may be automatically conducted.

Sixth Embodiment

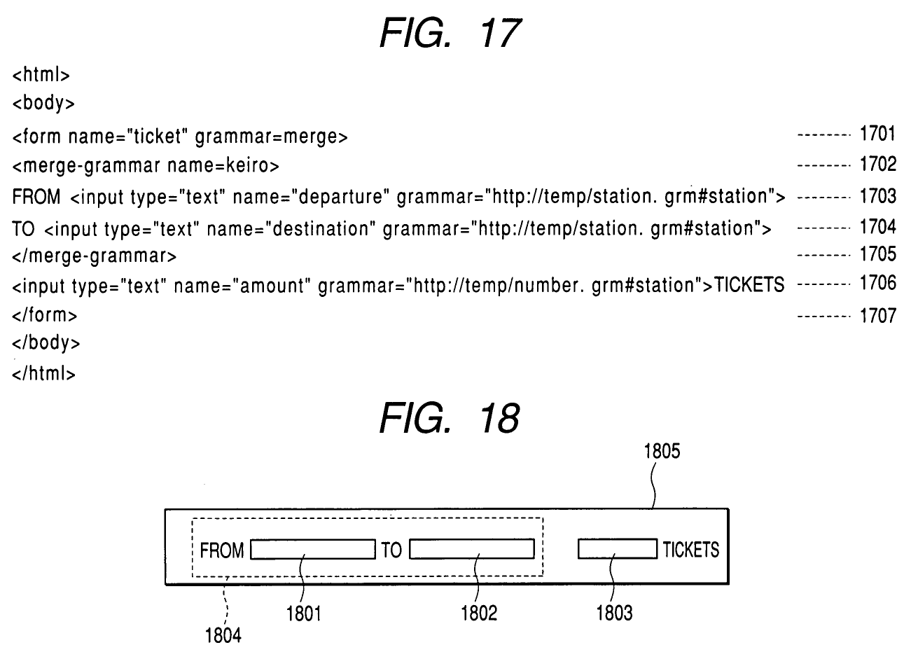

In the fourth embodiment, grammar data in which all grammar data described in the “form” are merged is generated by referring to values of the attribute “grammar” of the “form”. However, this is not restrictive. For example, it is also possible to previously determine tags that specify the start position and end position of a range in which grammars are merged, and merge the grammars only in the range interposed between the tags. An example of document data in this case is shown in FIG. 17.

In 1701, “merge” is specified in the “grammar” in the same way as the fourth embodiment. In the sixth embodiment, a grammar obtained by merging all grammars used in the “form” is associated with the “form”. Furthermore, a start point and an end point of a range in which grammars are partially merged are specified by 1702 and 1705. A grammar obtained by merging grammars described in the range interposed between “<merge-grammar>” and “</merge-grammar>” is created and used as a grammar to be used in the corresponding input range. An example in which FIG. 17 is displayed as GUI is shown in FIG. 18.

Input columns corresponding to “inputs” described in 1703, 1704 and 1706 are 1801, 1802 and 1803, respectively. Furthermore, a range in which grammars interposed between “<merge-grammar>” and “</merge-grammar>” is surrounded by a frame 1804. In addition, a region that belongs to the “form” is displayed by a frame 1805. In the same way as the first embodiment, an activated grammar is altered depending upon which region the user selects. For example, in the case where the input column 1804 is selected, it becomes possible to conduct inputting in forms “from ◯◯”, “to XX”, and “from ◯◯, to XX”. In the case where the whole “form” (1805) is selected, it becomes possible to conduct inputting in forms “Δ tickets” and “from ◯◯ to XX, Δ tickets” besides.

Seventh Embodiment

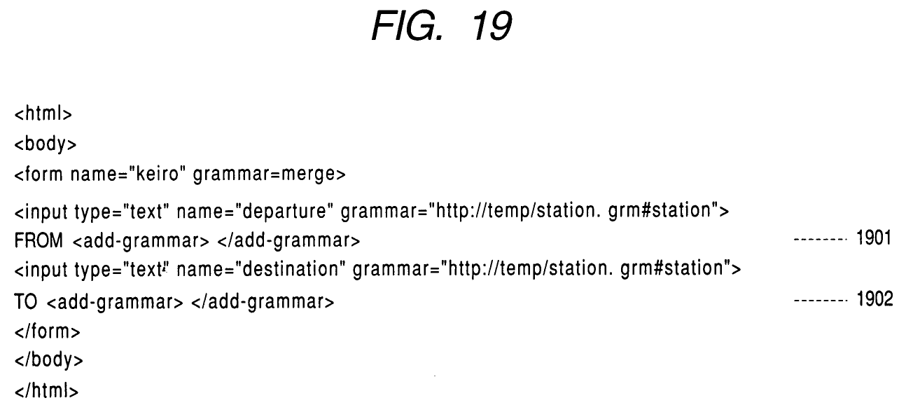

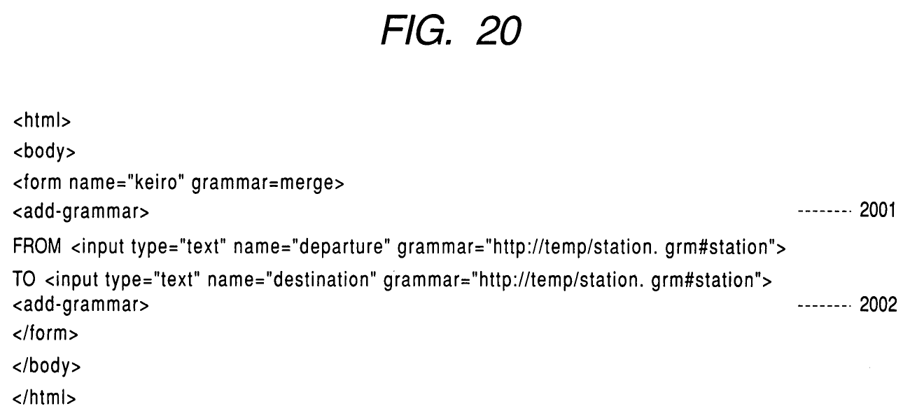

There will now be described an example (FIG. 16B) in which words and/or phrases, such as “from” and “to”, for display described in the “form” are taken in the grammar as words to be recognized, at the step S304 in the fourth embodiment shown in FIG. 13. As a method for explicitly specifying this, it is also possible to extract tags for specifying words and/or phrases to be taken in as words to be recognized when merging grammars and taking only words and/or phrases interposed between the tags in the grammar. An example of document data in that case is shown in FIG. 19. In this example, “<add-grammar>” and “</add-grammar>” indicated in 1901 and 1902 are tags for specifying a range of words and/or phrases to be taken in the grammar. In the case these tags are extracted, the document analysis section 1202 takes-words and/or phrases in the range interposed between the tags in the grammar and regards them as words to be recognized, when generating a merged grammar. As for a method for specifying words and/or phrases in the grammar by using “<add-grammar>” to. “</add-grammar>”, each of the words and/or phrases may be interposed between tags as shown in FIG. 19, or a start position (2001) and an end position (2002) of a range in which words and/or phrases to be taken in are described may be specified.

In either case, the grammar for the “form” generated in accordance with a result of analysis of the document data 1200 becomes the same as the grammar shown in FIG. 16B. In the case of a document in which tags for taking in words and/or phrases for display (i.e., document data shown in FIG. 14), “from” and “to” are not taken in the merged grammar and the grammar shown in FIG. 16A is generated.

By the way, the present invention includes the case where the present invention is achieved by supplying a software program for implementing the function of the above described embodiments (a program corresponding to the illustrated flow chart in the embodiment) directly or remotely to a system or an apparatus and by a computer of the system or apparatus that reads out and executes the supplied program code. In that case, the form need not be a program so long as it has a function of the program.

Therefore, a program code itself installed in the computer in order to implement the function processing of the present invention in the computer also implements the present invention. In other words, the present invention includes the computer program itself for implementing the function processing of the present invention as well.

In that case, the program may have any form, such as an object code, a program executed by an interpreter, or script data supplied to the OS, so long as it has a function of the program.

As a recording medium for supplying the program, there is, for example, a floppy disk, a hard disk, an optical disk, an optical magnetic disk, an MO, a CD-ROM, a CD-R. a CD-RW, magnetic tape, a nonvolatile memory card, a ROM, a DVD (DVD-ROM or DVD-R) or the like.

Besides, as a method for supplying the program, the program can also be supplied by connecting a client computer to a home page of the Internet by means of a browser of the client computer and downloading the computer program itself of the present invention or a file compressed and including an automatic installing function onto a recording medium such as hard disk from the homepage. It can also be implemented by dividing a program code forming the program of the present invention into a plurality of files and downloading respective files from different home pages. In other words, a WWW server that downloads a program file for implementing the function processing of the present invention in a computer to a plurality of users is also included in the present invention.

Furthermore, it is also possible to encrypt the program of the present invention, store the encrypted program in a storage medium such as a CD-ROM, distribute the program to users, making a user who has cleared a predetermined condition download key information for solving the encryption from a home page via the Internet, execute the encrypted program by using the key information, make the program installed in the computer, and implement it.

The computer executes the read program, and consequently implements the function of the embodiments is implemented. Besides, an OS running on a computer conducts a part or whole of the actual processing on the basis of the order from the program, and consequently the function of the embodiments can also be implemented by the processing.

In addition, a program read out from a recording medium is written into a memory included in a function expansion board inserted into a computer or included in a function expansion unit connected to a computer, and then a CPU included in the function expansion board or the function expansion unit conducts a part or whole of actual processing, and consequently the function of the embodiments can also be implemented by the processing.

### INDUSTRIAL APPLICABILITY

As heretofore described, according to the present invention, it is possible to provide a speech recognition apparatus capable of speech inputting having a degree of freedom and its method, and a program.

1. A speech recognition apparatus for recognizing input speech, comprising:
reading means for reading hypertext document data, the hypertext document data including a description for displaying input columns and a description concerning speech recognition grammar data to be applied to input speech for said input columns;
speech recognition means for conducting speech recognition on said input speech by using speech recognition grammar data corresponding to a plurality of input columns displayed on the basis of said hypertext document data; and
display means for determining input columns of input destinations of word groups obtained from a speech recognition result of said speech recognition means from said plurality of input columns on the basis of said speech recognition grammar data, and displaying said input columns of input destinations in corresponding input columns.

2. The speech recognition apparatus according to claim 1, further comprising:
specification means for specifying a plurality of input columns displayed on the basis of said hypertext document data,
wherein said speech recognition means conducts speech recognition on said input speech by using speech recognition grammar data corresponding to said plurality of input columns specified by said specification means.

3. The speech recognition apparatus according to claim 2, wherein said specification means can specify said plurality of input columns simultaneously.

4. The speech recognition apparatus according to claim 1, wherein said display means determines input columns of input destinations of word groups obtained from a speech recognition result of said speech recognition means from said plurality of input columns on the basis of said speech recognition grammar data, and displaying said input columns of input destinations in corresponding input columns simultaneously.

5. The speech recognition apparatus according to claim 1, wherein said hypertext document data and said speech recognition grammar data are managed in an external terminal connected to said speech recognition apparatus via a network.

6. The speech recognition apparatus according to claim 1, further comprising:
analysis means for analyzing said hypertext document data;
first holding means for acquiring said speech recognition grammar data corresponding to said input columns from an analysis result of said analysis means and holding said speech recognition grammar data so as to be associated with said input columns; and
second holding means for holding words so as to be associated with said input columns.

7. The speech recognition apparatus according to claim 1, further comprising:
morphological analysis means for effecting a morphological analysis on said speech recognition result,
wherein said display means determines input columns of input destinations of word groups obtained from said speech recognition result from said plurality of input columns on the basis of said speech recognition grammar data and a result of said morphological analysis of said morphological analysis means on said speech recognition result of said speech recognition means, and displaying said input columns of input destinations in corresponding input columns.

8. A speech recognition apparatus for recognizing input speech, comprising:
reading means for reading hypertext document data, the hypertext document data including a description for displaying input columns and a description concerning speech recognition grammar data to be applied to input speech for said input columns;
analysis means for analyzing said hypertext document;
generation means for generating speech recognition grammar data corresponding to predetermined input columns including a plurality of input columns included in said hypertext document on the basis of the analysis result of said analysis means;
speech recognition means for conducting speech recognition on said input speech by using speech recognition grammar data corresponding to said predetermined input columns displayed on the basis of said hypertext document data; and
display means for determining input columns of input destinations of word groups obtained from a speech recognition result of said speech recognition means from a plurality of input columns forming said predetermined input columns on the basis of said speech recognition grammar data, and displaying said input columns of input destinations in corresponding input columns.

9. The speech recognition apparatus according to claim 8, wherein
said analysis means comprises extraction means for extracting a description having no corresponding speech recognition grammar data, from among descriptions for displaying input columns included in said hypertext document, and
said generation means generates speech recognition grammar data corresponding to input columns corresponding to said description, on the basis of said description extracted by said extraction means.

10. The speech recognition apparatus according to claim 8, wherein
said analysis means comprises extraction means that extracts a predetermined description for generating speech recognition grammar data included in said hypertext document, and
said generation means generates speech recognition grammar data corresponding to said predetermined input column, on the basis of speech recognition grammar data specified on the basis of the predetermined description extracted by said extraction means.

11. The speech recognition apparatus according to claim 8, wherein
said generation means comprises extraction means that extracts a description for making text data of a display subject included in said hypertext document a speech recognition subject, and
said generation means generates speech recognition grammar data including said text data corresponding to input columns that corresponds to said description, on the basis of the description extracted by said extraction step.

12. A speech recognition method for recognizing input speech, comprising:
a reading step of reading hypertext document data, the hypertext document data including a description for displaying input columns and a description concerning speech recognition grammar data to be applied to input speech for said input columns;
a speech recognition step of conducting speech recognition on said input speech by using speech recognition grammar data corresponding to a plurality of input columns displayed on the basis of said hypertext document data; and
a display step of determining input columns of input destinations of word groups obtained from a speech recognition result of said speech recognition step from said plurality of input columns on the basis of said speech recognition grammar data, and displaying said input columns of input destinations in corresponding input columns.

13. The speech recognition method according to claim 12, further comprising:
a specification step of specifying a plurality of input columns displayed on the basis of said hypertext document data,
wherein said speech recognition step conducts speech recognition on said input speech by using speech recognition grammar data corresponding to said plurality of input columns specified by said specification step.

14. The speech recognition method according to claim 13, wherein said specification step can specify said plurality of input columns simultaneously.

15. The speech recognition method according to claim 12, wherein said display step determines input columns of input destinations of word groups obtained from a speech recognition result of said speech recognition step from said plurality of input columns on the basis of said speech recognition grammar data, and displaying said input columns of input destinations in corresponding input columns simultaneously.

16. The speech recognition method according to claim 12, wherein said hypertext document data and said speech recognition grammar data are managed in an external terminal connected to a pertinent speech recognition apparatus via a network.

17. The speech recognition method according to claim 12, further comprising:
an analysis step of analyzing said hypertext document data;
a first holding step of acquiring said speech recognition grammar data corresponding to said input columns from an analysis result of said analysis step and holding said speech recognition grammar data so as to be associated with said input columns; and
a second holding step of holding words so as to be associated with said input columns.

18. The speech recognition method according to claim 12, further comprising:
a morphological analysis step of effecting a morphological analysis on said speech recognition result,
wherein said display step determines input columns of input destinations of word groups obtained from said speech recognition result from said plurality of input columns on the basis of said speech recognition grammar data and a result of said morphological analysis of said morphological analysis step on said speech recognition result of said speech recognition step, and displaying said input columns of input destinations in corresponding input columns.

19. A speech recognition method for recognizing input speech, comprising:
a reading step of reading hypertext document data, the hypertext document data including a description for displaying input columns and a description concerning speech recognition grammar data to be applied to input speech for said input columns;
an analysis step of analyzing said hypertext document;
a generation step of generating speech recognition grammar data corresponding to predetermined input columns including a plurality of input columns included in said hypertext document;
a speech recognition step of conducting speech recognition on said input speech by using speech recognition grammar data corresponding to said predetermined input columns displayed on the basis of said hypertext document data; and
a display step of determining input columns of input destinations of word groups obtained from a speech recognition result of said speech recognition step from a plurality of input columns forming said predetermined input columns on the basis of said speech recognition grammar data, and displaying said input columns of input destinations in corresponding input columns.

20. The speech recognition method according to claim 19, wherein
said analysis step comprises an extraction step of extracting a description having no corresponding speech recognition grammar data, from among descriptions for displaying input columns included in said hypertext document, and
said generation step generates speech recognition grammar data corresponding to input columns corresponding to said description, on the basis of said description extracted by said extraction step.

21. The speech recognition method according to claim 19, wherein
said analysis step comprises extraction step that extracts a predetermined description for generating speech recognition grammar data included in said hypertext document, and
said generation step generates speech recognition grammar data corresponding to said predetermined input column, on the basis of speech recognition grammar data specified on the basis of the predetermined description extracted by said extraction step.

22. The speech recognition method according to claim 19, wherein
said analysis step comprises extraction step that extracts a description for making text data of a display subject included in said hypertext document a speech recognition subject, and
said generation step generates speech recognition grammar data including said text data corresponding to input columns that corresponds to said description, on the basis of the description extracted by said extraction step.

23. A program for causing a computer to function to conduct speech recognition for recognizing input speech, comprising:
a program code for a reading step of reading hypertext document data, the hypertext document data including a description for displaying input columns and a description concerning speech recognition grammar data to be applied to input speech for said input columns;
a program code for a speech recognition step of conducting speech recognition on said input speech by using speech recognition grammar data corresponding to a plurality of input columns displayed on the basis of said hypertext document data; and
a program code for a display step of determining input columns of input destinations of word groups obtained from a speech recognition result of said speech recognition step from said plurality of input columns on the basis of said speech recognition grammar data, and displaying said input columns of input destinations in corresponding input columns.

24. A program for causing a computer to function to conduct speech recognition for recognizing input speech, comprising:
a program code for a reading step of reading hypertext document data, the hypertext document data including a description for displaying input columns and a description concerning speech recognition grammar data to be applied to input speech for said input columns;
a program code for an analysis step of analyzing said hypertext document;
a program code for a generation step of generating speech recognition grammar data corresponding to predetermined input columns including a plurality of input columns included in said hypertext document on the basis of the analysis result of said analysis, step;
a program code for a speech recognition step of conducting speech recognition on said input speech by using speech recognition grammar data corresponding to said predetermined input columns displayed on the basis of said hypertext document data; and
a program code for a display step of determining input columns of input destinations of word groups obtained from a speech recognition result of said speech recognition step from a plurality of input columns forming said predetermined input columns on the basis of said speech recognition grammar data, and displaying said input columns of input destinations in corresponding input columns.

25. A speech recognition apparatus comprising:
reading means for reading data, the data including a description for displaying input columns and a description concerning speech recognition grammars for said input columns;
speech recognition means for conducting speech recognition on said input speech by using said speech recognition grammars; and
display means for determining input columns of input destinations of said speech recognition result from said plurality of input columns on the basis of said speech recognition grammars, and displaying said input columns of input destinations in corresponding input columns.

26. A speech recognition method comprising:
a reading step of reading data, the data including a description for displaying input columns and a description concerning speech recognition grammars for said input columns;
a speech recognition step of conducting speech recognition on said input speech by using said speech recognition grammars; and
a display step of determining input columns of input destinations of said speech recognition result from said plurality of input columns on the basis of said speech recognition grammars, and displaying said input columns of input destinations in corresponding input columns.

27. A program for causing a computer to function to conduct speech recognition for recognizing input speech, comprising:
a program code for a reading step of reading data, the data including a description for displaying input columns and a description concerning speech recognition grammars for said input columns;
a program code for a speech recognition step of conducting speech recognition on said input speech by using said speech recognition grammars; and
a program code for a display step of determining input columns of input destinations of said speech recognition result from said plurality of input columns on the basis of said speech recognition grammars, and displaying said input columns of input destinations in corresponding input columns.
